(19) United States
(12) Patent Application Publication
(10) Pub. No.: US 2003/0178070 A1
(43) Pub. Date: Sep. 25, 2003

(54) PEAK DEMAND FLOW CONTROLLER FOR WATER CONSERVATION

(76) Inventor: Lisa Ann Glicken, Orlando, FL (US)

Correspondence Address: Lisa A. Glicken, 1101 Seville Place, Orlando, FL, 32804, US

(21) Appl. No.: 10/103,604

(22) Filed: Mar. 21, 2002

(51) Int. Cl. F17D 3/00

(52) U.S. Cl. 137/624.11

(57) ABSTRACT

A Peak Demand Fresh Water Flow Controller For The Conservation of Water that can be directly and remotely controlled via the transmission of a signal as initiated in by a Utility for the express purpose of reducing or stopping the flow of water at the consumers' homes or buildings during times of water supply shortage or excess consumer demand.

### FEDERALLY SPONSORED RESEARCH

Not Applicable

### SEQUENCE LISTING OR PROGRAM

Not Applicable

### BACKGROUND—FIELD OF INVENTION

This invention relates to water flow controllers, specifically to Peak Demand Fresh Water Flow Controllers which conserve water by reducing or completely halting the flow of water through plumbing in consumer homes and buildings and are directly and remotely activated by the initiation and transmission of an external signal by a water district or Utility for peak demand-side management of municipal water supplies.

### BACKGROUND—DESCRIPTION OF PRIOR ART

The demand for fresh water in many cities around the world is exceeding, or is projected to exceed, the limited supply of this precious resource. Rapid or excessive population growth in areas with inadequate urban planning has forced Water Utilities to implement mandatory water conservation measures in the form of car washing bans, swimming pool filling bans, re-circulating fountain restrictions, and lawn irrigation restrictions. These restrictions have been enacted in order to preserve the dwindling water supplies and to prevent a water shortage. Periodic watering bans and water usage restrictions are only minimally effective in reducing overall water consumption. Such measures are based largely on a relatively unreliable and consumer-dependent honor system. Present day water restriction events require the consumer to manually turn off outside water consuming devices such as spigots, hose bibs, pool faucets, and sprinklers during times of low water supply or excessive demand as experienced by the Utility.

Casual and incomplete participation in the Utility water restrictions on the part of the consumer forces the Utility to deploy expensive enforcement patrols to manually turn off water using devices at the source of the usage. The enforcement patrols are also tasked to fine violators who choose to disregard or abuse the requirements of the specified water restrictions. Presently, the Utility has no means to directly and remotely reduce or control the overall water usage of their entire consumer base without detrimentally impacting the operation of normal water-using household appliances and drinking water.

Simpler, more automated, and internally regulated irrigation controls have been proposed in U.S. Pat. No. 6,227,220 to Addink 2001 May 8, for example, that provide merely irrigation control for the purpose of watering a lawn. Addink's irrigation controller is less dependent on the user entering the control parameters and is more reliant on the acquisition of externally received sensor data to automatically set and control the internal irrigation algorithm based upon historical rainfall data, evapotranspiration data, and other such atmospheric variables.

These systems are limited to and specified for irrigation purposes only, can make the consumption of water more efficient, more automated, and therefore, simpler to set-up by the user. However, the comprehensive conservation of water, especially during high peak demand periods, is ultimately left solely and unreliably in the hands of the consumer and not the Utility who more accurately comprehends the magnitude of the supply problem and who is ultimately responsible to control or resolve the problem to prevent a water outage to the entire community. Additionally, the proposed irrigation controller in U.S. Pat. No. 6,227,220 to Addink 2001 May 8, does not allow the Utility to take complete control of some or all of the consumer's water usage at the point of consumption. Addink's irrigation controller does not relinquish flow control to the Utility so that that Utility can ensure that complete participation in a water restriction event occurs via their direct control.

As the demand for fresh water continues to outpace the supply in many communities, comprehensive “WATER RESTRICTION” processes and technologies, as deployed by the Utility to take control of the water flow in consumers' homes, buildings, and land, are becoming necessary. Thus, there is a continuing need to provide peak demand-side management of fresh water supplies by the Utility in the consumers' homes and buildings. Insofar as I am aware, no water flow controller formerly developed provides complete and immediate demand-side control of water flow, at the point of consumption and use, in a remote manner as controlled by the Utility.

Objects and Advantages

Accordingly, besides the objects and advantages of a Utility controlled, peak demand, remotely accessed water flow control installed at the point of water consumption for the express purpose of conserving water, several objects and advantages of the present invention are:

(a) A controller that can be connected to electric water flow or solenoid valves installed anywhere in or outside of a structure where any type of water control is desired by a Utility from a remote location.

(b) A controller that controls water flow to any or all water consuming devices or spigots in a home or building via connection to an external solenoid valve installed in the plumbing system for the purpose of conserving water.

(c) A controller that is completely and externally controlled by the Utility.

(d) A controller that can be accessed by the Utility at any time of day so as to reduce or completely stop the flows of water at their consumers' homes, buildings, and land.

(e) An infrastructure and method that supports the organized initiation and transmission of a signal to one or multiple flow controllers.

(f) A controller that contains an algorithm that, upon receipt of a radio transmitted signal initiated by or at the request of the Utility, provides a voltage that can energize or close a water solenoid valve for a prescribed period of time.

(g) A controller that can be assigned a unique identity for the express purpose of being controlled individually or as a group of controls.

(h) A controller that can receive discrete transmissions that instruct the start of a WATER RESTRICTION and the discontinuation of a WATER RESTRICTION.

(i) A controller that features a visual status informing the consumer that the unit has received a signal from the Utility and is operating in WATER RESTRICTION mode.

(j) A controller that features an override that allows the consumer to, for a prescribed number of times and or duration, manually override a WATER RESTRICTION operation as initiated by the Utility.

(k) A controller that features a tamper switch that, when activated by the removal of tamper devices or panels enclosing or containing the control, writes data to on board memory indicating that tampering has occurred.

(l) A controller that features a power loss detect circuit that writes data to on board memory upon the loss and restoration of power to the controller.

(m) A controller whose stored data can be interrogated and manipulated by the Utility either remotely or locally.

(n) A controller that maintains a Real Time Clock (RTC) that can be updated by receipt of a transmission initiated by the Utility.

Further objects and advantages are to provide a controller which can be used to control the water usage throughout the structures and properties of entire cities and municipalities, which can be used repeatedly, and which obviates the need to deploy enforcement agencies to manually turn off water at consumer locations during times of peak demand. Still further objects and advantages will become apparent from a consideration of the ensuing description and drawings.

### SUMMARY

In accordance with the present invention, a Utility controlled, peak demand, fresh water, flow controller comprises an electronic control that has the capability of receiving transmission signals as directly initiated by the Utility for a WATER RESTRICTION event of specific duration and locality. With the exception of a consumer initiated override event, the controller is designed to take complete control of the flow of water at or beyond the point where the flow valve is installed in the plumbing system of the structure, thereby restricting or halting the flow of water at the location of consumption as commanded by the Utility.

The above described water flow controller requires a total surrendering of the consumer's preferred water flow, at or after the point where the flow valve is installed in the plumbing system, in favor of the Utility's water restriction in the event that an override is not elected. The water consumer is not afforded an opportunity to proceed forward with his or her desired and unrestricted use of water and is subject to a water savings modification thereto. This controller supports true demand side management of municipal water supplies as controlled by the Utility for genuine water conservation attainment.

### DRAWINGS

### Drawing Figures

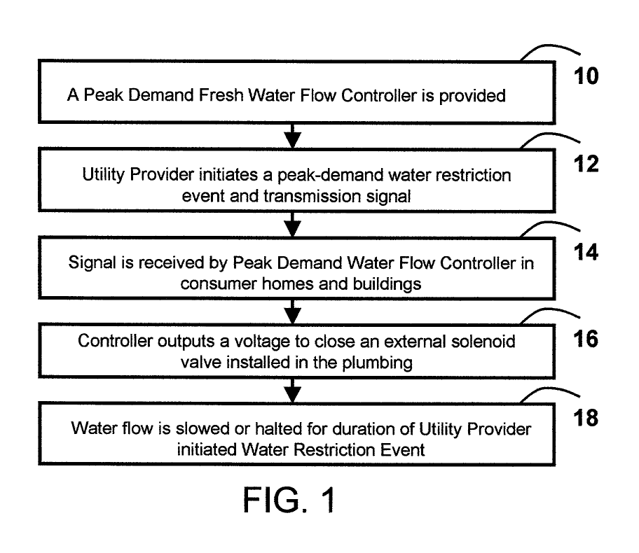

FIG. 1 is a flowchart and the sequence of events that occur, as initiated by the Utility, to instruct the flow controller to reduce or halt the flow of water on the consumers' property. The Peak Demand Fresh Water Flow Controller For The Conservation of Water is an integral part of this inclusive process.

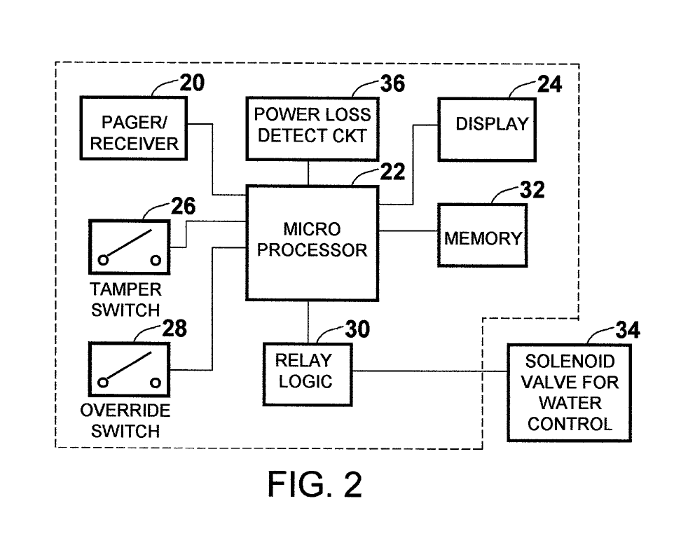

FIG. 2 is a diagram of the Peak Demand Fresh Water Flow Controller For The Conservation of Water

### Reference NUMERALS IN DRAWINGS

| | | | |
|---|---|---|---|
| 10 | fresh water controller provided | 12 | Utility initiates |
| | | | water restriction |
| 14 | signal received by controller | 16 | controller closes |
| | | | external valve |
| 18 | water flow halted during restriction | 20 | pager/receiver |
| 22 | microprocessor | 24 | display |
| 26 | tamper switch | 28 | override |
| 30 | relay logic | 32 | memory |
| 34 | solenoid for water valve | 36 | power loss detect |

### DETAILED DESCRIPTION

Description—Figs. 1 and 2—Preferred Embodiment

FIG. 1 illustrates a process that includes the Peak Demand Fresh Water Flow Controller 10, as initiated and transmitted through a signal by a Utility 12 during times of peak demand on the municipal water supply. The signal is received 14 by each flow controller, sending a voltage to close an external solenoid valve 16. Water flow at the point of consumption is reduced or halted completely 18.

FIG. 2 shows a basic version of my Peak Demand Fresh Water Flow Controller. The integrated pager/receiver 20 of the flow controller is connected to the input of the microprocessor 22. The memory 32, display 24, relay logic 30, override switch 28, tamper switch 26, and power loss detect 36 are also connected electrically to the microprocessor. The solenoid valve for water control 34 is connected to external electrical contacts located on the flow controller housing.

Various objects, features, aspects and advantages of the present invention and process will become more apparent from the following detailed description of preferred embodiments of the invention and process, along with the accompanying drawings in which like numerals represent like components.

Operation of Invention

Referring to FIG. 1, the Peak Demand Fresh Water Flow Controller is connected 10 to an external electric relay or solenoid valve installed in a structure's plumbing main supply or piping that exits to external valves, spigots, faucets, or other outdoor water consuming devices. Ideally, the solenoid valve will be located such that all hose bibs, spigots, pool faucets, fountains, and sprinklers are controlled by the valve. A WATER RESTRICTION signal will be deployed at the discretion of the Utility at times of water crisis 12, excessive demand, or during spontaneously or pre-planned conservation events as defined by the Utility. The signal, when received by the water flow controller 14, will start an operation or “WATER RESTRICTION” event that relinquishes water control from the consumer, closing the electric solenoid valve 16 and halting or reducing the flow of water 18 for comprehensive water conservation.

Referring to FIG. 2, the integrated pager/receiver 20 of the flow controller will receive a signal or page as initiated by the Utility. The microprocessor 22 interprets the received signal, stores the date and time of the signal reception in memory 32, activates the display 24 to alert the consumer of the event, and begins a WATER RESTRICTION cycle. The microprocessor then provides an output to the relay logic 30 circuit. The relay logic circuitry, in turn, provides a voltage for a prescribed period of time to an external solenoid valve, keeping the solenoid valve 34 closed for a prescribed period or until such time that the Utility sends an optional signal that re-establishes consumer control, subsequently opening the attached solenoid valve and returning the flow of water to the consumer.

The water flow controller will incorporate an override switch 28 that allows the consumer to regain control of the water during prescribed periods within the “WATER RESTRICTION” event. The override event status, date, and time is stored in memory 32.

During a “WATER RESTRICTION”, the water flow controller will provide visual indication 24 to the consumer that the system is in “WATER RESTRICTION” mode. An optional feature will provide a visual or audible indication of the amount of time elapsed and remaining under the “WATER RESTRICTION” event.

The water flow controller will include a tamper switch 26 that will store tamper status, date, and time information in memory in the event that a consumer attempts to open the water flow controller case. Further, any attempt to disconnect the external solenoid valve wiring or any attempt to remove power to the flow controller will results in a tamper status, date, and time to be written to memory.

The water flow controller will include a power loss detect circuit 36 that will store power loss status, date, and time information in memory in the event of a power loss to the controller.

The water flow controller will contain non-volatile memory 32 that retains data such as time of day, date, install date, “WATER RESTRICTION” event count, override count, tamper indication, etc. This data will be made available to the Utility via optional devices that interrogate the control either locally or remotely.

The water flow controller will update its own internal real time clock and date on a regular basis when the Utility transmits a signal providing a time and date update.

CONCLUSIONS, RAMIFICATIONS, AND SCOPE

Thus the reader will see that the Peak Demand Fresh Water Flow Controller For The Conservation of Water of the invention provides direct remote control by the Utility of the fresh water usage at the point of consumption or use. It is highly advantageous that no reliance is placed on the consumer to abide by water restriction guidelines nor is any manual intervention on the part of the consumer required to conserve water. Rather, the Utility assumes complete and direct control of their customer water flow remotely via transmission of a WATER RESTRICTION event and the subsequent closing of a flow control valve, thereby reducing water consumption when desired and saving water.

While my aforementioned description contains many specifications, these should not be construed as limitations on the scope of the invention, but rather as exemplification one of preferred embodiment thereof. Many other variations are possible. Accordingly, the scope of the invention should be determined not by the embodiment(s) illustrated, but by the appended claims and their legal equivalents.

I claim:

1. A process executable by a programmed processor within an electronic fresh water flow controller for reducing or halting the flow of fresh water in consumers' homes and buildings for the conservation of water that responds directly to the external transmission of a signal initiated by a Water Utility mandating that the controller enters into a mode of operation specifically defined by the external communication, said process comprising:
a. receiving at least one external communication mandating that the fresh water flow controller enter into a mode of operation defined by the external communication;
b. storing information contained within the external communication;
c. instructing the flow controller to modify the local operation of a solenoid valve installed in the plumbing at the point of consumption, said process further comprising:
i. at least one instruction to be used to modify the local operation of a solenoid valve installed in the plumbing at the point of consumption to reduce or halt the flow of water;
ii. indicating a status on the display so as to display the mode of operation to the consumer;
iii. storing information related to the time and date of the signal receipt;
iv. periodically inquiring as to whether the consumer has requested an override as initiated by pressing an override button;
v. terminating the mode of operation defined by the external communication in response to the consumer's request to override the mode of operation, and;
vi. storing information that identifies that an override was requested by time and date

2. A peak demand fresh water flow controller having the capability to receive a remote request or transmission instructing the controller to enter into a mode of operation defined by the external communication, said controller comprising but not limited to:
a. A receiver capable of receiving external signals;
b. memory for storing information;
c. relay or solid state logic and conditioning circuitry to drive or control an external solenoid valve;
d. a tamper switch attached to the product and control wires connected to the external solenoid valve that when activated, stores information related to the tamper event to the memory;
e. a circuit to detect power loss that when power loss is sensed, stores information related to the power loss event to memory;
f. an override switch that when activated, terminates the mode of operation initiated by the external communication and stores information related to the override event in memory;
g. a display that indicates the mode of operation of the controller;
h. a processor operative to receive at least one communication from the hierarchical control system requesting that the controller enter into a mode of operation defined by the external communication, the information contained in the communication including at least one instruction to command an external device, said processor being operative to store information contained in the communication in said memory, said processor being operative to read a portion of the stored information containing at least one instruction, said processor furthermore being operative to send a control signal or voltage to an external solenoid valve installed in the plumbing system at the point of consumption or demand.
whereby said control will be employed to implement a peak demand, demand-side WATER RESTRICTION event that provides comprehensive water usage reduction and savings as initiated and controlled by the Utility.
